(19) United States
(12) Patent Application Publication
(10) Pub. No.: US 2018/0177316 A1
(43) Pub. Date: Jun. 28, 2018

(54) Integrated Knife Rack

(71) Applicant: Nami Khademhosseini, Falls Church, VA (US)

(72) Inventor: Nami Khademhosseini, Falls Church, VA (US)

(21) Appl. No.: 15/904,365

(22) Filed: Feb. 25, 2018

Related U.S. Application Data
(63) Continuation-in-part of application No. 15/462,807, filed on Mar. 18, 2017, now Pat. No. 9,962,026.
(60) Provisional application No. 62/493,158, filed on Jun. 24, 2016.

(51) Int. Cl. A47G 21/14; A47J 43/28; A47J 47/00; A47J 47/16

(52) U.S. Cl. CPC A47G 21/14; A47J 47/16; A47J 47/005; A47J 43/28

(57) ABSTRACT

In one example, we describe a device for an efficient and compact rack system for knives and other kitchenware. This stylish design integrates: One or more (e.g., three) grinders, a cutting/chopping board, a tray, and a complete full size knife rack, as an example. All these kitchen tools are specifically designed to fit in the same space that a full-size knife rack normally takes. We have also shown a flexible compartment for various tools/storage, based on 3 different structures: 1. Accordion shaped vertical structure. 2. X-shaped or + shaped vertical structures. 3. Straw or thin bar vertical structures. Many different variations are shown here, as well.

### RELATED APPLICATIONS

This application is CIP of another application Ser. No. 15/462,807, filed on 18 Mar. 2017, with the same inventor, which is based on a provisional application 62/493,158, filed on Jun. 24, 2016, with the same inventor. We claim priority on the above filing dates. We incorporate by reference all the teachings of the above applications in this application.

### BACKGROUND OF THE INVENTION

Usually, in the kitchen and table, there is not enough space for everything needed. So, there is a need for Integrated Knife Rack with Tray and Spice Containers or Grinders, plus Chopping Board. It is a space saver and efficient kitchen countertop rack in which it integrates big pieces of kitchen tools that need to be kept handy, while keeping them organized and saving countertop space at the same time. Flexibility for various types and sizes is very important in a rack design, to save space on the countertop in the kitchen, with a clean and organized system. No other prior art has solved this problem this way and this efficiently, even the ones offered by Evo Solo Angled Al knife stand or Mantello Universal knife block, as the prior art.

### SUMMARY OF THE INVENTION

In one embodiment, we describe a method and a device for such a rack system. This stylish design integrates: One or more (e.g., Three) grinders or spice containers, a cutting/chopping board, a tray, and a complete full size knife rack. All these kitchen took are specifically designed to fit in the same space that a full-size knife rack normally takes.

We have also shown a flexible compartment for various tools/storage, based on 3 different methods:
1. Accordion shaped vertical structure:
   a. solid or flexible;
   b. one size hole, or multiple size holes;
   c. tray under the bottom, with holes on the bottom, to drain the water in the tray, for evaporation or clean up later on.
2. X-shaped or + shaped vertical structures:
   a. solid or flexible;
   b. one size hole, or multiple size holes;
   c. tray under the bottom, with holes on the bottom, to drain the water in the tray, for evaporation or clean up later on.
3. Straw or thin bar vertical structures:
   a. rigid or flexible;
   b. hollow or solid inside;
   c. tray under the bottom, with holes on the bottom, to drain the water in the tray, for evaporation or clean up later on.
   d. A fan on top to dry the knives faster, attached to the structure from the top.

Many different variations are shown here, as well.

### BRIEF DESCRIPTION OF THE DRAWINGS

FIG. 1 is for one embodiment, as an example, for the rack.

FIG. 2 is for one embodiment, as an example, for cylindrical grinder to keep salt and pepper and other spices. (The grinders may be in cylindrical, rectangular, circular, triangular, or other forms or shapes, in cross section or length.)

FIG. 3 is for one embodiment, as an example, for the rack at side view. Mainly, it shows the cross positioning of the knife blades between the top and lower rows.

FIG. 4 is for one embodiment, as an example, for the cutting board.

FIG. 5 is for one embodiment, as an example, for a tray.

FIG. 6 is for one embodiment, as an example, for side view of the system or assembly.

FIG. 7 is for one embodiment, as an example, for the tray/board that need two small folding legs inside the tray wall. These legs will level the board, when in open position.

FIG. 8 is for one embodiment, as an example, for triangular shaped compartment, at the side or back of the knife rack, or stand or holder or storage or organizer, or for other kitchenware. It can be any shape, or cross section, or at any side, integrated or detachable from/to the main body.

FIG. 9 is for one embodiment, as an example, for a variation of shape of the compartment, at the side or back of the knife rack, or stand or holder or storage or organizer, or for other kitchenware.

FIG. 10 is for one embodiment, as an example, for a variation of shape of the compartment, at the side or back of the knife rack, or stand or holder or storage or organizer, or for other kitchenware.

FIG. 11 is for one embodiment, as an example, for hollow or solid straws or bars, to hold knives and other objects vertically, to store or dry up, flexible for many sizes, due to its nature.

FIG. 12 is for one embodiment, as an example, for accordion shape structure, to hold knives and other objects vertically, to store or dry up, flexible for many sizes, due to its nature.

FIG. 13 is for one embodiment, as an example, for x-shaped vertical structures, to hold knives and other objects vertically, to store or dry up, flexible for many sizes, due to its nature.

FIG. 14 is for one embodiment, as an example, for + shaped vertical structures, to hold knives and other objects vertically, to store or dry up, flexible for many sizes, due to its nature. It can have any other shape similar or in-between those in FIGS. 13 and 14.

FIG. 15 is for one embodiment, as an example, with 4 various options/compartments, for holding, i.e., for cross shaped vertical structures, along with straws, plus accordion shaped, and zig-zag shaped or W-shaped (with option to have a regular slit/section, as shown in other figures, as well as drain holes and tray at bottom, plus a tray/chopping board, as optional, folded at the back side), to hold knives and other objects vertically, for flexibility/convenience for different sizes.

### DETAILED DESCRIPTION OF THE PREFERRED EMBODIMENTS

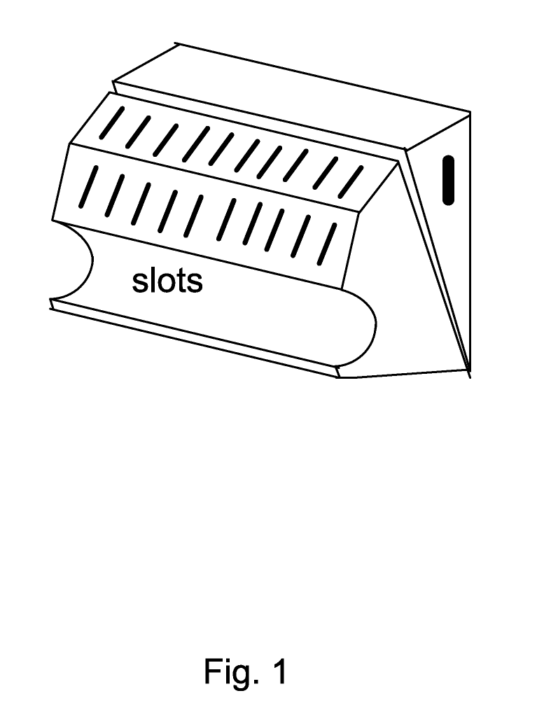

The invention enables efficient usage of the space in the kitchen. These are some variations, embodiments, or examples: The knife rack of FIG. 1 shows the look of the knife rack with the multifunctional board stored in its designated space in the back, between the rack and the wall, in a 90-degree angle to the countertop, which works as a cutting board and tray.

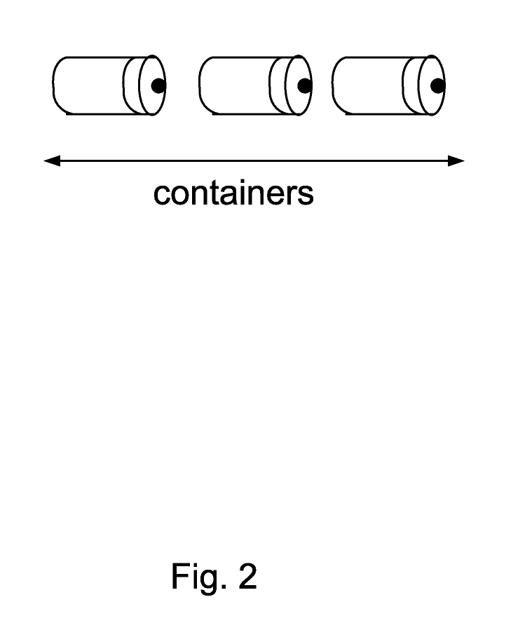

The cylindrical grinder (FIG. 2) is to keep salt and pepper and other spices handy. These grinders are vertically positioned in the concaved groove in front-bottom of the knife rack (FIG. 1). They also use caps to prevent from accidental dispensing.

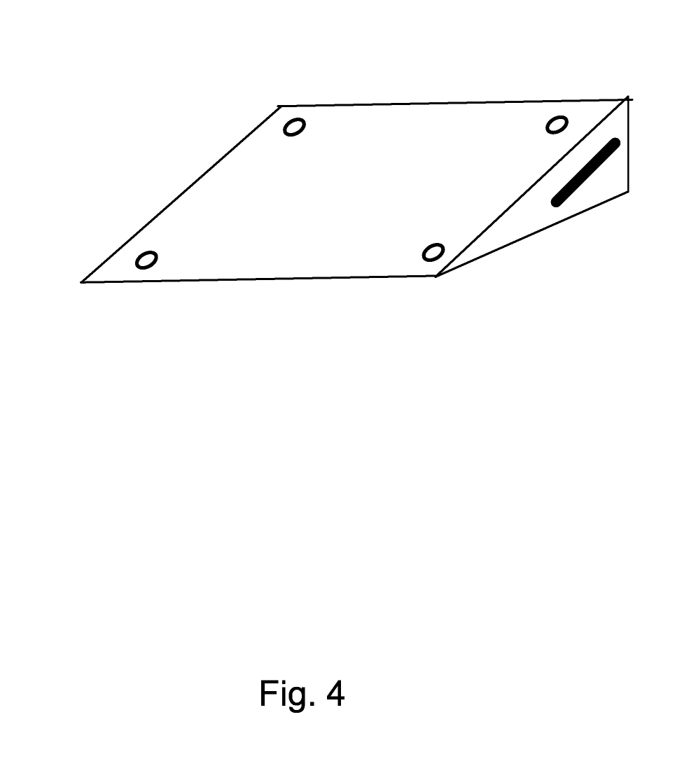

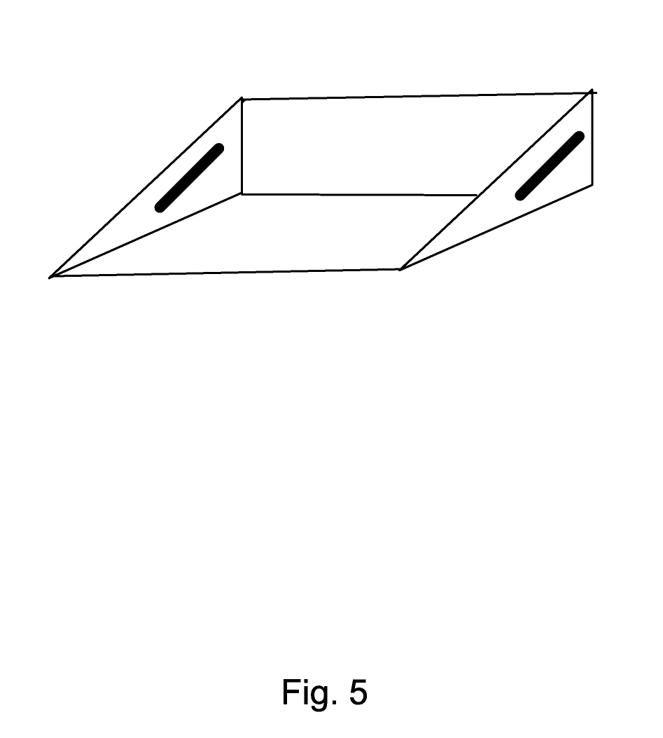

The drawing in FIG. 4 shows the cutting board when is pulled out of the knife rack for use. This piece can easily slide in or out, sideway. FIG. 4 shows the board while is pulled out and placed on a surface to be used as a cutting or chopping board. The same board can be turned over and be used as a tray (FIG. 5). In this position, the four convex buttons on four corners keep the bottom off the table or countertop surface, and in upright position, and when stowed away, it will keep the chopping board surface from touching the wall.

The top knife slots are designed so that they do not cross in 90 degree angle (e.g., less than 90 degrees), to the second row at the bottom, to allow knife blade from top row position in between others at the bottom row. Therefore, the knife handle makes a smaller angle to the horizontal surface of the countertop, and allows the user to put the larger or longer knives out or put back in easily, without bumping her wrist to the top cabinet, which is very inconvenient, especially in the small standard space between the countertops and top cabinets, which is about 18-24 inches, e.g., 20 inches.

This invention also eliminates the storage need for 6 common and frequently used kitchen tools that need to be kept handy on the countertop, and also helps keeping the kitchen organized within one stylish and space-efficient unit, that takes the same space as a full-size conventional knife-rack.

In one embodiment, we have:

1. Each row of knife holder slots on this rack is designed with two different angles for two sets of positioning in the rack, which facilitates placing or removing the knives in and out of the rack, for example, within the small space between the kitchen countertop and the top wall mounted cabinets (about 18-24″), by creating a closer or smaller angle to the horizontal plane/support surface (countertop), where the rack is placed on.

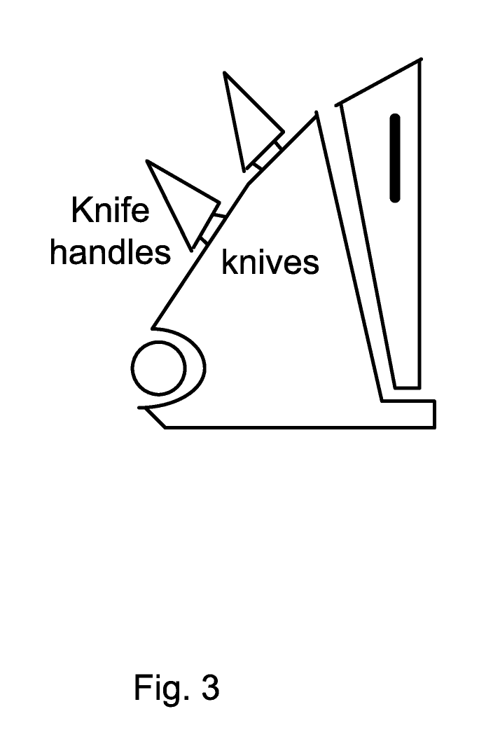

The top row of knife slots can have up to 75 (e.g., about 70) degree angle, as one example, and the lower row can be more than e.g. 30 degree angle, to the countertop surface, which is placed in between the top rows (FIG. 2). In one embodiment, we have the lower row of slots positioned in different vertical zone, comparing to the upper row, and placed in between the upper row of knife slots (FIG. 3).

The said positioning allows the blade of the knives in the lower row of slots to fit in between the knives' blades' tips that are put in the upper row, so that the knives in upper slots and lower slots do not intersect, therefore, all the knives in both rows fit in the rack properly.

2. The tray and chopping board are actually one-piece with different use on each sides, and can be used for either purpose (tray or chopping board), as the user reverses the part or turns it upside down. The said part can slide behind the rack in the space between the rack and the wall behind the rack, over the narrow slot along the width of the rack at the bottom, and behind the rack.

The said slot that holds the narrow side of the tray/chopping board part not only helps with space efficient storing, but also helps with draining the tray and chopping board, while this multipurpose part is in the stored position in the back of the rack (FIG. 1).

3. The rectangular tray and chopping board combination can be used in two different positions: When used with surface up (FIG. 4), it can be used as chopping board with a slight slope towards the user, and higher side away from the user.

When the said part is reversed with the hollow side up, it can be used as a tray (FIG. 5). The said part comprises of four small convex buttons, or like ridge, on each corner, that works as small supports or legs which separate the bottom surface of the part from any surface the tray is put on, in order to keep the bottom chopping board surface touch-free and clean.

The said part is used as a tray when the surface is down. It provides space inside to put anything needed in the tray, and has a hollow space on each of the right and left rectangular sides, which can be used as handles to carry the tray.

4. This design shows a new horizontal positioning of spice cellars or grinders (FIG. 2), in the horizontal space designed in the front of the rack.

The integrated rack (FIG. 1) shows the look of the knife rack with the multifunctional board stored in the back, between the rack and the wall behind it, in 90 degree angle, which works as cutting board on one side and tray on the reverse side.

Cylindrical spice shakers (grinder/shaker) (FIG. 2) is vertically positioned in the groove in front-bottom of the knife rack (FIG. 1). The drawing in FIG. 4 shows the cutting board when is pulled out of the rack for use. It has slope that is placed towards the user, while in use as cutting or chopping board.

The said part can be turned over and be used as a tray (FIG. 5). The said surface has four small convex supports on each corner, which prevent the cutting board surface under the tray from touching other surfaces, such as countertop and tables in order to keep it contact-free and clean.

The slots for holding knife are designed to allow knife blade from top row positioned in between others in bottom row, as perpendicular, therefore, the knife handle making a smaller angle to the horizontal surface of table or countertop, and allowing the user to put the long knives easily in the small space between the countertop and top cabinets, which is about 24 inches, for example.

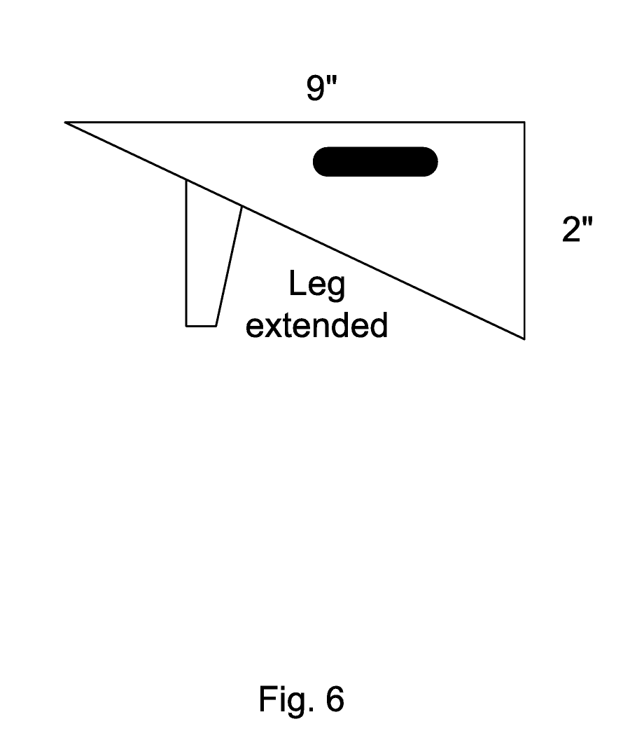

FIGS. 5 and 6 show the tray/board that can incorporate two small folding legs inside the tray wall. These legs will level the board, when in open position. In one example, these small legs are part of the tray wall, when in closed position. This design eliminates the storage need for at least 5 necessary kitchen tools including knife rack, two grinders, tray, and chopping board that need to be kept handy at all times. By doing so, all the space for storing these kitchen tools integrates into a one efficient and space saving rack.

The other embodiments are described below, referring to pages of Figures in Appendix 1, FIGS. 1-18:

1) The first photo shows that the triangular ay wall. Fingertip slot has an angle to the top of the triangular wall, which creates a special ergonomic angle between the palm, wrist, and the arm of the user, creating a comfortable position.

2) It shows that the foldable legs can transfer the tray (in reverse position) to a chopping board that has a clearance space under, to place a container, in which the chopped food is dropped from the chopping board surface.

3) It shows the capacity of the knife rack, and how many pieces of kitchenware it is capable of storing, very efficiently, with least space taken from the kitchen countertop.

4) It shows how the tray part is put or removed from the rack.

5) & 6) It shows the close up of the mechanism of the folding leg inside the tray wall.

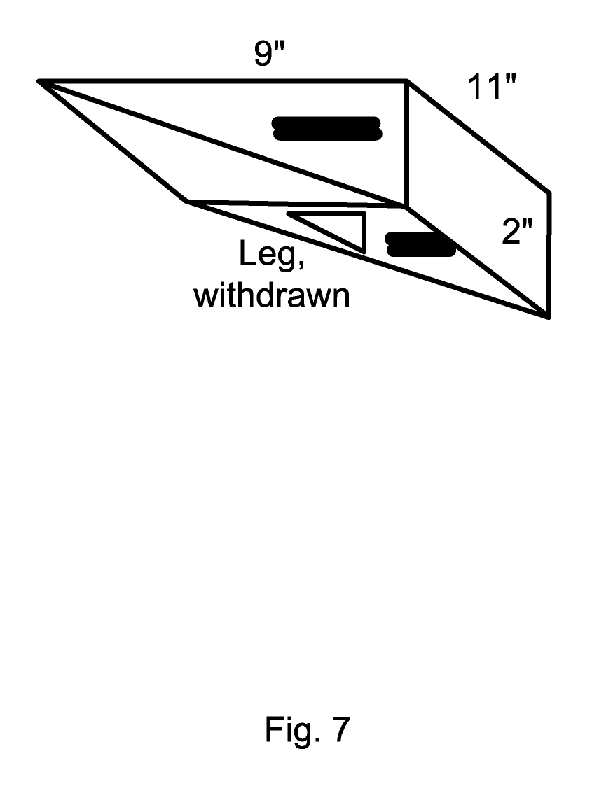

Note that the first 6 photos in Appendix 1, FIGS. 1-6, mentioned above, are examples for the main invention, and the rest, Appendix 1, FIGS. 7-18, are additional photos in different angles, for variations and better descriptions. Appendix 2, FIGS. 1-2, are also additional photos in different angles, for variations and better descriptions.

In one embodiment, we have: A knife rack system, said system comprising: a housing; one or more slots for holding one or more knives within said housing; a board; and a spice container section. Other variations are:

a tray.

chopping board without folding legs.

chopping board with suction units for stability.

wherein said board is converted to a tray.

a knife sharpening tool.

one or more legs or stands or arms.

one or more legs or stands or arms which is foldable.

said one or more slots are at least 2 slots, and said one or more slots have different sizes or dimensions for slots.

said one or more slots are at least 2 slots, and said one or more slots have different angles or directions for slots.

said one or more slots are at least 2 slots, and said one or more slots have same sizes or dimensions for slots.

said one or more slots are at least 2 slots, and said one or more slots have same angles or directions for slots.

an inclined surface.

a handle or grip location.

one or more hinges.

a slide flat tray.

a spice container.

one or more spice containers or grinders.

salt/pepper shakers or containers.

one or more gaps for air circulation.

a bottom tray for water drainage under said housing, with one or more gaps in said housing.

said housing is waterproof or water-resistant.

said housing is made of metal, alloy, wood, or plastic.

one or more elastic suction units under said housing, for stability or grip of said housing on a countertop or table, so that the housing does not move or get toppled down, holding tight to the surface underneath.

For the regular Figs., we have: FIG. 1 is for one embodiment, as an example, for the rack. FIG. 2 is for one embodiment, as an example, for cylindrical grinder to keep salt and pepper and other spices. FIG. 3 is for one embodiment, as an example, for the rack at side view. FIG. 4 is for one embodiment, as an example, for the cutting board.

FIG. 5 is for one embodiment, as an example, for a tray. FIG. 6 is for one embodiment, as an example, for side view of the system or assembly. FIG. 7 is for one embodiment, as an example, for the tray/board that need two small folding legs inside the tray wall. These legs will level the board, when in open position. Please note that the sizes and parameters in Figs. are all examples, and not limiting for the general teaching at all.

Please note that the handle of the tray in figures above can be wide, or narrow, in both directions, and it can be parallel to any of the lines or sides, or not parallel, or in between those lines, e.g., as a bisector line or median line, with respect to each side or face of the object or plane of the object. So, the direction of the handle gap or slit or slot or opening or hole or cross section can go from parallel to perpendicular, and to any angle in between, with respect to each side or face of the object or plane of the object or tray. The shape of the handle gap or slit or slot or opening or hole or cross section can be oval, circle, rectangle, square, triangle, pentagon, polygon, curved-ended, sharp-comers, ellipse, wide line, narrow line or band, or the like.

In one embodiment, we have Integrated Knife Rack with Tray(s), Chopping Board(s), and Spice Containers or Grinders, or other kitchenware or apparatuses or devices or tools, e.g., screw driver or flash light, for other variations.

The material and size of the system or apparatus described here can be widely diverse and different, e.g., made of wood, plastic, elastic, rubber, artificial materials, wool, fabric, glass, crystal, metal, alloy, carbon, mortar, concrete, brick, clay, transparent materials, translucent materials, acrylic, stone, artificial stone, compacted stone or powder, glued materials, layered or stacked materials, or the like, and e.g., for sizes around from 0.5″ or 0.5 ft as lower end of the range, to 3-6 ft, as upper range or values, in length and width and height, or other dimensions, in the images shown. However, these numbers and materials are just examples, and not limiting the invention by any means, in spec or figures or for any purpose.

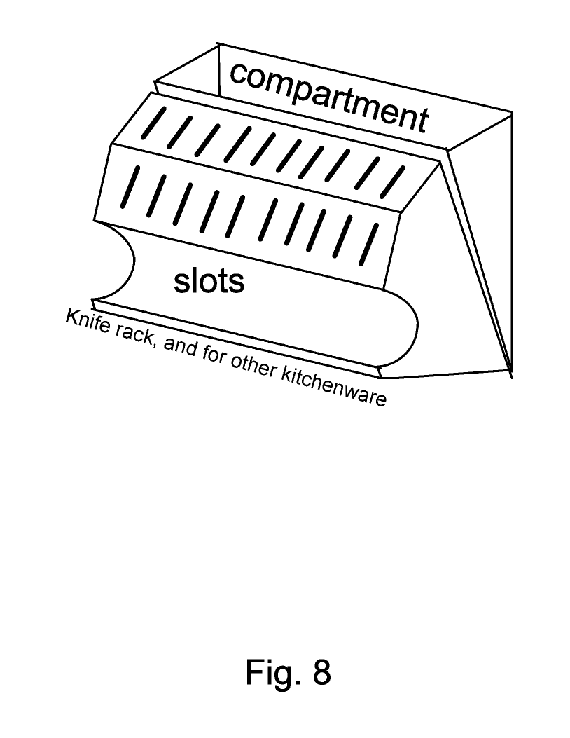

FIG. 8 is for one embodiment, as an example, for triangular shaped compartment, at the side or back of the knife rack, or stand or holder or storage or organizer, or for other kitchenware. It can be any shape, or cross section, or at any side, integrated or detachable from/to the main body. In one embodiment, as an example, we have a compartment, within the housing, that holds the knives and other objects, as a universal holder or storage, without any conventional slit for the knives on the front side. In one embodiment, as an example, we have any single or combination of compartment, open area, and specific slots or slits for knives and other objects, alone or in combination with other options mentioned here, as shown in FIGS. 8-14, or any FIGS. 1-7, or any of the teachings of appendices, alone or any combination thereof. So, for example, the housing can be only the compartment, comprising the straws only, in one embodiment.

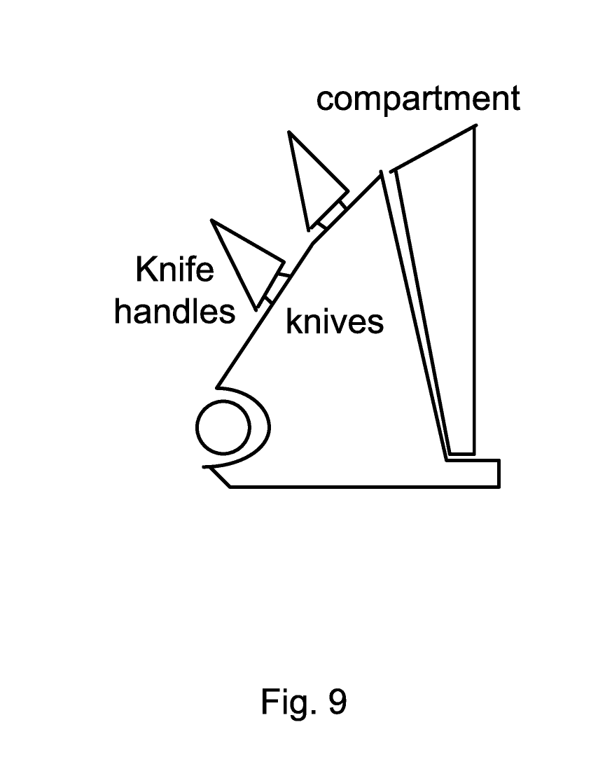

FIG. 9 is for one embodiment, as an example, for a variation of shape of the compartment, at the side or back of the knife rack, or stand or holder or storage or organizer, or for other kitchenware.

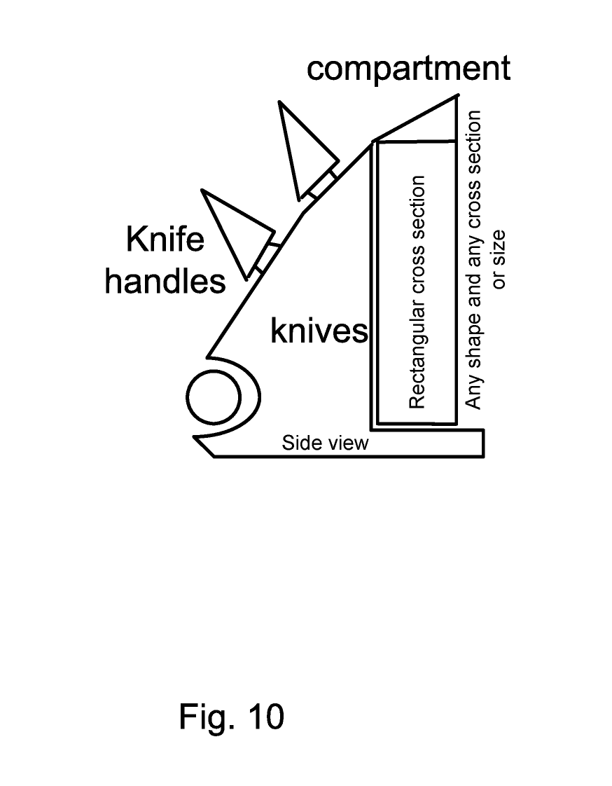

FIG. 10 is for one embodiment, as an example, for a variation of shape of the compartment, at the side or back of the knife rack, or stand or holder or storage or organizer, or for other kitchenware. The bottom portion of the main body, shown in FIG. 10, under the compartment, shown in the side view, is a permanent tray, extended out under the compartment, attached to the main body, for collecting water, to dry the knives, with holes directly on top of the tray extended section cover, and water going through the holes on bottom of the rectangular compartment, connecting and draining the water from the rectangular compartment to the tray below, as shown in FIG. 10, on the bottom right side of the main body, directly under the rectangular compartment. The bottom portion of main body acts as tray, as shown in FIG. 10, as the bottom line in the side view. It can also have a heater or fan in the tray section or above, to speed the process for drying.

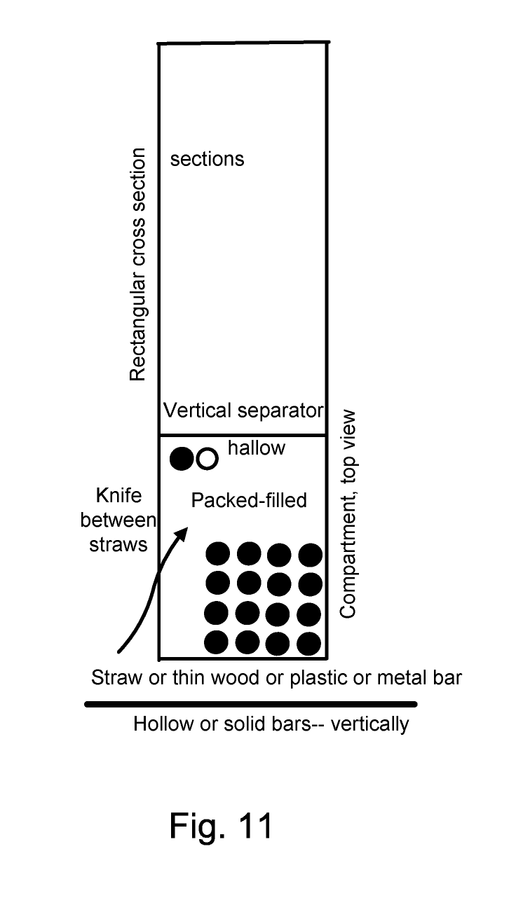

FIG. 11 is for one embodiment, as an example, for hollow or solid straws or bars, to hold knives and other objects vertically, to store or dry up, flexible for many sizes, due to its nature.

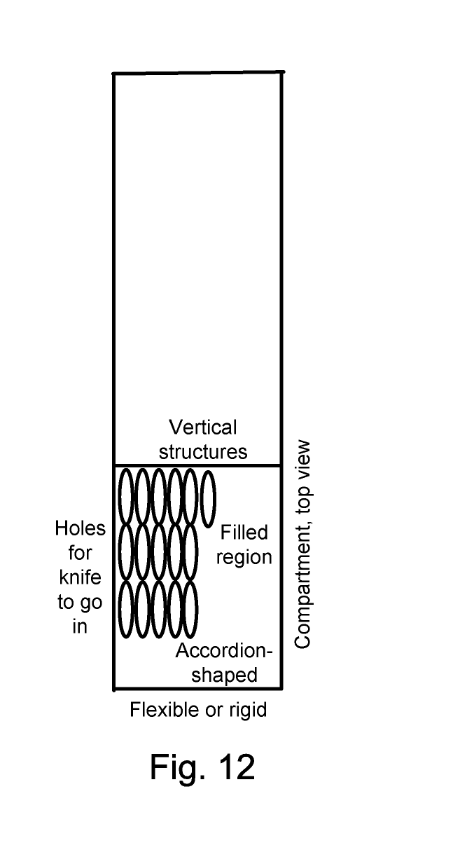

FIG. 12 is for one embodiment, as an example, for accordion shape, or Zig-Zag shape structure, adjustable or rigid or flexible partitioning, with curved or straight lines, to hold knives and other objects vertically, to store or dry up, flexible for many sizes, due to its nature, for knife stand or rack or holder or storage or organizer or block or housing, for angled or vertical storage.

In one embodiment, we have: A universal knife rack system, said system comprising: a housing; one or more slots for holding one or more knives within said housing; a compartment located on back or side of said housing; multiple straws or bars; wherein said multiple straws or bars are positioned vertically in said compartment, covering horizontal cross section of said compartment.

In one embodiment, we have the following variations: an accordion shaped structure; wherein said accordion shaped structure is positioned vertically in said compartment, covering horizontal cross section of said compartment. Or, we have these options/variations: a cross-hatched shaped structure; wherein said cross-hatched shaped structure is positioned vertically in said compartment, covering horizontal cross section of said compartment.

Or, we have these options/variations:

wherein said cross-hatched shaped structure is X-shaped.

wherein said cross-hatched shaped structure is shaped.

wherein said cross-hatched shaped structure is flexible.

wherein said cross-hatched shaped structure is rigid.

wherein said cross-hatched shaped structure is adjustable.

wherein said cross-hatched shaped structure has various size holes.

wherein said cross-hatched shaped structure is water-proof.

wherein said cross-hatched shaped structure does not get mold.

wherein said multiple straws or bars are hollow.

wherein said multiple straws or bars are filled inside.

wherein said multiple straws or bars are flexible.

wherein said multiple straws or bars are rigid.

wherein said multiple straws or bars are made of elastic or rubbery materials.

wherein said accordion shaped structure is made of elastic or rubbery materials.

wherein said accordion shaped structure is rigid.

wherein said accordion shaped structure is adjustable.

wherein said accordion shaped structure is waterproof or water-resistant.

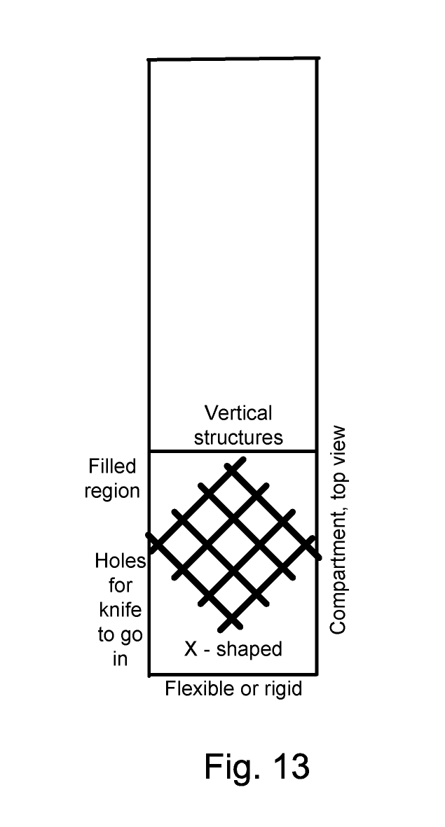

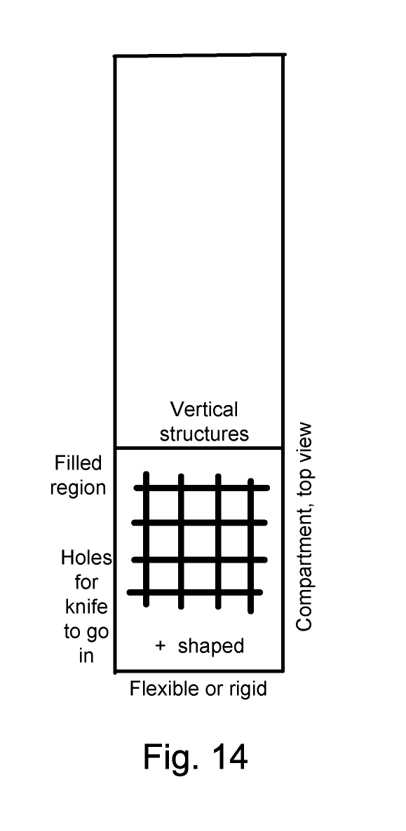

FIG. 13 is for one embodiment, as an example, for x-shaped vertical structures, to hold knives and other objects vertically, to store or dry up, flexible for many sizes, due to its nature. FIG. 14 is for one embodiment, as an example, for + shaped vertical structures, to hold knives and other objects vertically, to store or dry up, flexible for many sizes, due to its nature. It can have any other shape similar or in-between those in FIGS. 13 and 14.

Appendix 3 page 1 is a system with multiple array of slits for knives and others, with salt shaker holder/ section at the bottom portion, located horizontally, with folded tray/board at the back of the system, detachable, as a separate part. Page 2 shows the tray of the above system. Page 3 shows another system, with a tilted section for magazines, as a magazine holder, on the opposite side. Page 4 shows the chopping board as another version/use of the same tray, with legs extended, at the bottom, making it horizontal/flat, but it is generally adjustable for the angle with respect to the ground or countertop.

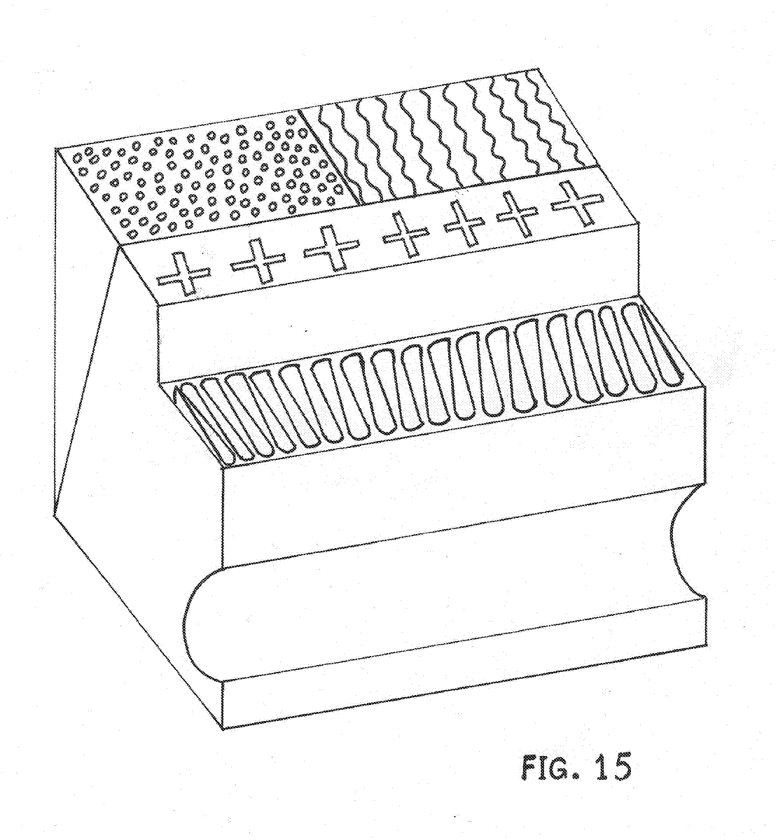

FIG. 15 is for one embodiment, as an example, with 4 various options/compartments, for holding, i.e., for cross shaped vertical structures, along with straws, plus accordion shaped, and zigzag shaped or W-shaped (with option to have a regular slit/section, as shown in other figures, as well as drain holes and tray at bottom, plus a tray/chopping board, as optional, folded at the back side), to hold knives and other objects vertically, for flexibility/convenience for different sizes. It can also be combined with all teachings in other figures and appendices, as well as other parts of this disclosure, as an embodiment.

For example, the straws and bars or accordions or x-shaped or + shaped structures can be made of wood, metal, alloy, plastic, steel, stainless steel, aluminum, laminated, paper, card board, elastic material, rubber material, or rigid, flexible, hollow, or solid materials, or the like, with small pieces attached together (e.g., with glue, band, or hinges), or as a one-piece structure.

Any variations and combinations of the above teachings are also intended to be covered by this patent application.

1. A universal knife rack system, said system comprising:
a housing;
a compartment located on back or side of said housing;
multiple straws or bars;
wherein said multiple straws or bars are positioned vertically in said compartment, covering horizontal cross section of said compartment.

2. A universal knife rack system, said system comprising:
a housing;
a compartment located on back or side of said housing;
an accordion shaped structure;
wherein said accordion shaped structure is positioned vertically in said compartment, covering horizontal cross section of said compartment.

3. A universal knife rack system, said system comprising:
a housing;
a compartment located on back or side of said housing;
a cross-hatched shaped structure;
wherein said cross-hatched shaped structure is positioned vertically in said compartment, covering horizontal cross section of said compartment.

4. The universal knife rack system, as recited in claim 3, wherein said cross-hatched. shaped structure is X-shaped.

5. The universal knife rack system, as recited in claim 3, wherein said cross-hatched shaped structure is cross-shaped.

6. The universal knife rack system, as recited in claim 3, wherein said cross-hatched shaped structure is flexible.

7. The universal knife rack system, as recited in claim 3, wherein said cross-hatched shaped structure is rigid.

8. The universal knife rack system, as recited in claim 3, wherein said cross-hatched shaped structure is adjustable.

9. The universal knife rack system, as recited in claim 3, wherein said cross-hatched shaped structure has various size holes.

10. The universal knife rack system, as recited in claim 3, wherein said cross-hatched shaped structure is water-proof.

11. The universal knife rack system, as recited in claim 3, wherein said cross-hatched shaped structure does not get mold.

12. The universal knife rack system, as recited in claim 1, wherein said multiple straws or bars are hollow.

13. The universal knife rack system, as recited in claim 1, wherein said multiple straws or bars are filled inside.

14. The universal knife rack system, as recited in claim 1, wherein said multiple straws or bars are flexible.

15. The universal knife rack system, as recited in claim 1, wherein said multiple straws or bars are rigid.

16. The universal knife rack system, as recited in claim 1, wherein said multiple straws or bars are made of elastic or rubbery materials.

17. The universal knife rack system, as recited in claim 2, wherein said accordion shaped structure is made of elastic or rubbery materials.

18. The universal knife rack system, as recited in claim 2, wherein said accordion shaped structure is rigid.

19. The universal knife rack system, as recited in claim 2, wherein said accordion shaped structure is adjustable.

20. The universal knife rack system, as recited in claim 2, wherein said accordion shaped structure is waterproof or water-resistant.
